(19) United States
(12) Patent Application Publication
(10) Pub. No.: US 2010/0316436 A1
(43) Pub. Date: Dec. 16, 2010

(54) BINDING OF STACKED FLAT PARTS

(75) Inventor: Ferdinand FUCHS, Nuertingen (DE)

Correspondence Address: GREENBLUM & BERNSTEIN, P.L.C., 1950 ROLAND CLARKE PLACE, RESTON, VA, 20191, US

(73) Assignee: KUGLER-WOMAKO GMBH, Nuertingen (DE)

(21) Appl. No.: 12/797,277

(22) Filed: Jun. 9, 2010

(30) Foreign Application Priority Data
Jun. 11, 2009 (DE) 102009025105.7-26
Jan. 28, 2010 (EP) 10151959.3

(51) Int. Cl. B42F 13/04

(52) U.S. Cl. 402/57

(57) ABSTRACT

Method and apparatus for binding stacked flat parts, and bound stacked flat parts. The stacked flat parts are provided with perforations. The method includes coupling several individual fingers on an outer sheet, applying an adhesive to a predetermined area of the fingers, inserting the fingers into the perforations of the stacked flat parts, so that the fingers are bent in a spiral-like manner, and positioning an portion of each finger in overlapping contact with the predetermined area of respective fingers.

### CROSS-REFERENCE TO RELATED APPLICATIONS

The present application claims priority under 35 U.S.C. §119(a) of German Patent Application No. 10 2009 025 105.7 filed Jun. 11, 2009 and of European Patent Application No. 10 151 959.3 filed Jan. 28, 2010, the disclosures of which are expressly incorporated by reference herein in their entireties.

### BACKGROUND OF THE INVENTION

1. Field of the Invention

The invention relates to a method for the binding of stacked flat parts, in particular sheets of paper, in which the flat parts are provided with perforations. Furthermore, the invention relates to an apparatus for the binding of stacked flat parts, in particular sheets of paper, in which the flat parts are provided with perforations, and bound flat parts, in particular sheets of paper.

2. Discussion of Background Information

Blocks or stacked flat parts made of paper or the like, such as brochures, user's guides, calendars, notepads, etc., should they need to be opened, will be bound with a binding comb or the like.

Moreover, it is known that stacks of paper like writing or note pads using glue strips or wire combs or the like are bound together on one side.

For example, EP-B-0 704 322 describes a binding comb for holding together a stack of sheets, wherein the back part and fingers of the binding comb are disclosed as a single-layer, one-piece plastic binder, which is produced in an injection molding process.

Moreover, WO-A-2006/090644 discloses a multi-layer, one-piece paper comb binder with ring-like loops.

### SUMMARY OF THE INVENTION

Starting from the above-noted state of the art, embodiments of the invention provide a simple and fixed binding of paper layers or respectively paper stacks. In this way, it should be possible to provide a variably configurable and/or variably producible binding.

Accordingly, embodiments of the invention are directed to a method for the binding of stacked flat parts, in particular sheets of paper, in which the flat parts are provided with several perforations for the receipt of fingers or respectively tongue-like sections of an outer sheet. In a preparatory step several individual figures are arranged on an outer sheet, in particular, a finger-free or first or initially finger-free outer sheet, in order to form an outer sheet with several or respectively a plurality of fingers. The fingers of the outer sheet are or will be provided in a predetermined area with an adhesive and the fingers are inserted into the perforations of the stacked flat parts such that the fingers will be or are bent as a loop in a spiral-like manner like a coiled roll. A preferably adhesive-free area of each finger is brought into overlapping contact with an area of the respective finger provided with adhesive.

The invention is based on the idea that, in a preparatory step, an initially finger-free or binding-tongue-free outer sheet, e.g., a base sheet without fingers or respectively binding tongues or the like, is provided with fingers. In this regard, individual or isolated fingers or binding tongues are arranged, preferably permanently fastened, on the outer sheet. Each of the individual or isolated fingers or binding tongues is or will be arranged or adhered to the outer sheet separately.

Through the outer sheet or respectively the outer sheet assembled in an outer sheet assembling device with outwardly pointing or outwardly projecting free ends as fingers or binding tongues, a multi-piece outer sheet is produced for insertion into the perforations of the stacked, flat parts to be bound. The material and the geometric properties of the fingers and/or the material and the geometric properties of the outer sheet are each correspondingly selected and aligned or respectively combined together after a predetermined request. For example, it is thereby possible to variably produce or provide a multi-piece outer sheet with different colored fingers and/or fingers with different thicknesses and/or lengths etc. for binding the flat parts. The binding tongues are in particular arranged on one side of a base area of the outer sheet or respectively base sheet.

The base area of this outer sheet or respectively base sheet or cover sheet thereby corresponds with the base area of the paper sheets or respectively flat parts to be joined. Due to the fact that the fingers or respectively binding tongues arranged or respectively fastened on the outer sheet via the a preparatory step, stick out at a right angle or parallel to each other as free ends of the base area of the outer sheet, a multi-material and/or multi-piece, i.e., non-single-piece, outer sheet can be provided such that for example when the base area of the outer sheet is made of paper, the tongues or respectively binding fingers or respectively loops or the like can then be made of another material. Furthermore, the end-side, separate fingers arranged on the outer sheet can be different, e.g., in material and/or in thickness and/or in length and/or color and/or shape or respectively design.

In the case of a single-material, multi-piece outer sheet, i.e. that the fingers and the outer sheet are made of the same material, no disassembling processes need to be performed for the recycling of a writing pad bound with it made only of paper, which are otherwise necessary for example in the case of a wire comb binder of a writing pad with a wire comb made of metal.

Within the framework of the invention, it is conceivable that other substances or respectively materials, such as plastic, can be used for the outer sheet with the fingers as well as for the flat parts. In turn, the outer sheet with the fingers arranged thereon through the preparatory step can be made of the same material. Also in this case, no disassembling processes are to be executed for the recycling of a bound writing pad e.g. made only of plastic, which are otherwise necessary for example in the case of a wire comb binder of a writing pad with a wire comb made of metal.

The fingers or respectively binding tongues preferably have the same material strength or respectively material thickness as the base area of the outer sheet. Within the framework of the invention, it is also possible that the fingers or binding tongues arranged on the outer sheet and the outer sheet have different thicknesses. Moreover, in another embodiment, the fingers can also have different thicknesses and/or lengths.

Moreover, another idea of the invention is based on the fact that during the formation of the binding, a loop binding or a type of roll loop binding is designed on one side of the flat parts to be joined, since the fingers or respectively binding tongues of the outer sheet provided as free ends, which will be or are rolled up like a loop and can be joined together in a contact area. In this overlapping contact area, the binding tongues or respectively the fingers of the outer sheet are designed like a single roll or respectively a multiple spiral-like rolling. A type of single loop or multiple loop, in particular double loop, is hereby formed. A first outer area of the fingers, which is adhesive-less or provided with an adhesive, is thereby brought into overlapping contact with a second area of the respective finger provided with adhesive. In one embodiment, a reactivatable or respectively activatable adhesive is applied to the fingers on both sides of the outer sheet, preferably in advance.

According to the invention, a rolled-up loop binding, for example for calendars or for writing pads, is thus formed. The loop binding is made of the same material, for example, paper or cardboard, as the material of the entire outer sheet or respectively base or cover sheet. In particular, this type of single-material binding as a comb binding or as a multiple-loop binding is formed according to the requirements with respect to the binding. Moreover, the comb binding or respectively loop binding can be a part of the outer sheet or respectively the base sheet or the cover sheet with the separate fingers arranged on it and can thus include multiple pieces, since the outer sheet with the other pieces is provided in the form of fingers.

In an alternative solution, a method is provided for the binding of stacked flat parts, in particular sheets of paper. The flat parts are provided with perforations for the receipt of fingers or respectively binding tongues of an outer sheet. In a preparatory step, several individual fingers are arranged on an, in particular finger-free or first or initially finger-free, outer sheet so that an outer sheet is provided with several fingers. The fingers of the outer sheet, preferably provided on their free ends projecting from the outer sheet and adhesive-free, are inserted into the perforations of the stacked flat parts so that the fingers will be or are bent in a spiral manner like a rolled-up roll. One area of the fingers will be or is brought into overlapping contact with another area, and subsequently the overlapping contact areas of the respective fingers are permanently joined together, preferably by radiation energy and/or the introduction of heat.

Within the framework of the invention, a non-detachable connection is a permanent and preferably wear-resistant connection, which is preferably not non-destructive in the case of the opening or respectively releasing of the connection.

In embodiments of the method, during the loop formation, i.e., during the insertion of the binding tongues designed as free ends into the perforations of the flat parts to be joined, portions of the fingers or binding tongues are joined through bending of the fingers or respectively binding tongues to contact the already existing adhesive mass onto the respective fingers on the inside. In other embodiments of the method, the fingers, which are first inserted into the perforations of the flat parts to be joined together, are designed in an overlapping area in a loop-like or rolled-up manner, so that the overlapping contact areas of the respective fingers are joined together in an unreleasable or respectively permanent manner. It is, for example, conceivable that an additional material is inserted into the fingers of the outer sheet, which reacts in the contact area and hardens after the loop formation through application of microwaves, UV radiation or laser beams or IR radiation or respectively heat, as well as through ultrasound application or the like. Within the framework of the invention, a welding is also possible for the formation of an unreleasable loop binding. A stable loop binding or respectively binding for a writing or respectively note pad loop is hereby also provided.

In accordance with the invention, the binding loops or respectively fingers are arranged on the outer sheet, i.e. on the base sheet or on the cover sheet, on one side as free and projecting ends. The length of the free ends of the fingers for the bindings is measured such that a predetermined joint overlapping area is created during the formation of the binding loop, i.e. during the curving of the fingers into the perforations of the flat parts. Through the cutting of the uncoiled fingers or respectively loop tongues, it is possible to form different loop diameters, and it is possible to bind paper layers with different thicknesses with one outer sheet with corresponding fingers.

In a preferred embodiment of the method, the individual fingers are connected with the preferably finger-free outer sheet, preferably during the preparatory step. The fingers are adhered, for example, to the outer sheet so that the ends of the fingers arranged on the outer sheet are or will be permanently and firmly connected with the outer sheet. In this way, the free ends of the fingers protruding (at first) from the outer sheet, after preparation of the outer sheet, will be used or are provided for the binding of the flat parts. After the binding process of the flat parts is complete, the (originally free) ends of the fingers, which are or will be inserted into the perforations of stacked flat parts, are coiled or curved in a loop-like manner.

In particular, the individual fingers are provided as finite finger sections with a predetermined length in one magazine or in several magazines and are subsequently conveyed from the magazine or from the magazines to the outer sheet to be provided with the fingers, simultaneously or in a predetermined sequence.

In accordance with an alternative embodiment of the method, it is provided that the individual fingers are cut as finite finger sections with a predetermined length from one or more endless, preferably coiled, finger material strips and the cut finger material strip sections as fingers are subsequently conveyed to the outer sheet provided with the fingers, simultaneously or in a predetermined sequence.

Moreover, the method is characterized in a further embodiment in that before arrangement of the fingers on the outer sheet the fingers or the finger material strips are processed by at least one processing device, preferably a printing device and/or embossing device. By the printing device, an imprint is applied to the fingers or binding tongues preferably in the area of the fingers, which is visible after a loop formation and remains detectible in the produced and bound final product. It is possible by the embossing device to provide the binding tongues in the preparatory step with a predetermined embossing, such as prism, groove, button or window embossing or the like. For example, it can be required in the case of a desired binding of paper sheet stacks that the binding tongues designed as fingers are or will be pre-creased since a pre-creasing of the binding tongues is or respectively can be supportive in the positioning before the gluing on the base sheet. The creasing is or will be preferably arranged along the inside of the base sheet.

The fingers or the finger material strips are preferably provided with glue, in particular a glue pattern, before arrangement of the fingers on the outer sheet and/or the outer sheet is or will be provided with glue, in particular with a predetermined glue pattern. In particular, the ends of the fingers, which are arranged on the outer sheet and are connected with the outer sheet, are provided with glue or an adhesive or the like. During the preparatory step of the outer sheet, the free ends of the fingers or binding tongues protruding from the outer sheet are not glued.

Moreover, it is advantageous in a process step that, for the arrangement of the fingers on the outer sheet, the individual fingers are inserted into respective perforations. One of the ends of the fingers is connected with the outer sheet and the respective other ends of the fingers stick out as free ends from the outer sheet. In particular, the fingers arranged on the outer sheet are arranged such that the each of the fingers engage behind the webs of the respective perforations, preferably designed on the edge of the outer sheet. It is hereby possible that the ends of the fingers arranged on the outer sheet are arranged are arranged inside on the produced, bound flat part stack after the binding process and can thus not be seen from the outside.

Furthermore, it is beneficial in one embodiment of the method that the ends of the fingers connected with the outer sheet will be or are arranged facing inward and the bound flat parts after binding of the stacked flat parts.

Within the framework of the invention, it is also possible that, instead of the preparatory step, a non-single-piece outer sheet provided with several fingers is also provided. The outer sheets are hereby designed such that the individual fingers are arranged on the outer sheets or base sheets, wherein the fingers and the respective outer sheet are not made of one piece, e.g., sheets of paper.

Moreover, one embodiment of the method is characterized in that the outer sheet with the individual fingers arranged on it or respectively provided with the individual binding tongues is conveyed flat to the stacked flat parts. During the conveyance of the outer sheet onto the fingers, in particular the free ends of the fingers or respectively binding tongues of the outer sheet, adhesive will be or is applied and the outer free ends of the fingers are inserted into the perforations of the flat parts, which are brought in contact with the areas of the fingers provided with adhesive under further conveyance of the outer sheet. The loop binding of the fingers is hereby fixed accordingly, so that the formed loop is immobilized preferably with adhesive at the transition point. In this manner, bound material or respectively flat parts of the stack are prevented from being removed from the formed loop, since a permanent and unreleasable connection is formed in the contact area of the rolled-up fingers or respectively binding tongues.

Furthermore, it is provided in accordance with an advantageous embodiment of the method that the adhesive is applied to the inside of the fingers of the outer sheet, in particular next to the base area of the outer sheet. Accordingly, the outer free ends of the fingers or respectively the end areas of the fingers are bent or curved into the perforations of the flat parts during the insertion process and are brought in contact with the adhesive area designed on the finger after the formation of a complete loop. It is particularly advantageous if a reactivatable adhesive is employed or respectively used as the adhesive. Potential adhesive contamination during the binding process is hereby advantageously prevented or respectively avoided.

In order to achieve a simple insertion of the free ends of the fingers or respectively binding tongues of the outer sheet, it is also provided that the flat parts to be joined are or will be arranged pushed up against each other before production of the bound stack so that the perforations of the flat parts, preferably in cross-section, are arranged in a curved or semi-circular manner so that the perforations of the surface form a type of bent channel for the binding tongues.

Moreover, it is advantageous in one embodiment if adhesive is applied to the fingers in sections during a, preferably linear, conveyance of the flat outer sheet before insertion of the fingers into the perforations of the flat parts. In particular, the adhesive is thereby applied to the inside of the fingers or respectively binding tongues of the outer sheet, which is assigned to the stacked or respectively bound flat parts after formation of the ring- or respectively loop-like binding. The adhesive is hereby applied in the root area of the fingers between the base area of the outer sheet and the outer free ends or respectively end sections of the fingers, wherein the outer free ends or respectively end sections of the fingers, which are first inserted into the perforations, are adhesive-free.

In one embodiment, it is possible that the outer free ends or respectively the end sections of the fingers are coated with a reactivatable adhesive or respectively glue, which only reacts after the loop binding and through the application of energy, e.g., heat energy, and thereby first softens and then hardens to achieve an unreleasable connection of the formed loops. The reactivatable adhesive can thereby be applied to one or both sides of the fingers.

In a further embodiment, it is also conceivable that the outer ends or respectively end sections of the fingers have a, preferably included or integrated, additive such as a sealer or the like, which only reacts after the loop binding and after a corresponding activation by the application of energy and thereby hardens in order to achieve an unreleasable connection of the formed loops.

Moreover, the method is characterized in that during the insertion of the fingers into the perforations of the flat parts, the base area of the outer sheet, on which the fingers are arranged, and the stacked flat parts are or will be arranged tilted towards each other. In this way, the loop formation or respectively the insertion of the fingers into the perforations is facilitated.

Embodiments of the present invention are directed to an apparatus for the binding of stacked flat parts, in particular sheets of paper, with a preferably metal-free binding. The flat parts are provided with perforations, which is further developed in that an outer sheet assembling device is provided so that several individual fingers will be arranged or are arrangeable on an in particular finger-free outer sheet by the outer sheet assembling device so that an outer sheet with several fingers will be or is provided for inserting into the finger insertion device on the output side of the outer sheet assembling device. A finger insertion device is provided for the insertion of fingers of an outer sheet so that the fingers are or will be bent in a spiral-like manner or respectively bent in a rolled up manner and an area of the fingers inserted into the perforations of the flat parts will be or is brought into overlapping contact with another area of the respective finger. A conveyor device is provided for the conveyance of the outer sheet designed with fingers so that one outer sheet can be conveyed to the finger insertion device, and the finger insertion device is provided with a receiver for a stack of flat parts to be bound. The binding provided for binding the sheets of paper is designed as a plurality of fingers or respectively binding tongues, which engage with the perforations of the flat parts or are brought to engage with the perforations. In particular, the binding is designed as an outer sheet with fingers arranged on it.

When using the apparatus together with a stack of flat parts to be bound and an outer sheet with corresponding fingers or respectively binding tongues, it is possible to design a permanent binding of the flat parts.

Individual binding tongues or fingers are arranged on the initially finger- or binding-tongue-free outer sheet by the outer sheet assembling device designed as an outer sheet preparation device, preferably in a preparatory step, particularly permanently fastened or glued, so that the outer sheet of the finger insertion device provided with binding tongues or respectively fingers as free ends is subsequently conveyed.

Furthermore, it is advantageously provided in the apparatus that the outer sheet assembling device has at least one or more magazines for the individual fingers of finite length and that a finger transfer device is provided so that the fingers of the finger-free outer sheet are conveyable by the finger transfer device. In particular, the fingers are thereby inserted into the perforations or elongated holes of the outer sheet provided for this.

Furthermore, one embodiment of the apparatus is characterized in that the outer sheet assembling device has at least one receiving device for at least one, preferably endless and/or coiled up, finger material strip and one cutting device for cutting the, preferably partially coiled up, finger material strip into finger material strip sections as individual fingers of finite length and in that a finger transfer device is provided so that the fingers can be conveyed to the finger-free outer sheet by means of the finger transfer device.

In accordance with another embodiment of the device, it is provided that the outer sheet assembling device has at least one processing device for the finger material strips, preferably a printing device and/or embossing device. In particular, the processing device related to the conveying direction of the fingers conveyed to the outer sheet is arranged in front of the location of the combination of the outer sheets with the fingers.

Moreover, it is preferably beneficial on the apparatus that a glue application device for the individual fingers or a glue application device for the, preferably endless, finger material strips and/or a glue application device for the outer sheet are provided for the outer sheet assembling device.

Moreover, the apparatus is characterized in that a finger connecting device is arranged on the finger insertion device such that in particular the finger insertion device has a binding loop forming device and/or a guide shell, such that the overlapping contact areas of the rolled up fingers are joined together. A type of loop forming apparatus is hereby designed, and the outer sheet is conveyed with the fingers or respectively binding tongues arranged on it or glued and is curved into or respectively inserted into the perforations of the flat parts by the finger insertion device. In particular, the binding loop forming device has one or several guide shells, wherein at least one guide shell is provided for each finger or a binding tongue of an outer sheet in one embodiment.

In one embodiment, the apparatus is also characterized in that an adhesive application device is arranged on the conveyor device so that adhesive can respectively be applied to an area of the fingers of the outer sheet.

For this, it is also provided that the adhesive application device applies adhesive along the adhesive application device during the conveyance of the outer sheet.

Furthermore, one embodiment of the apparatus is characterized in that the conveyor device for the outer sheet is designed as a suction belt conveyor that can be supplied with negative pressure from a negative pressure source and/or has a cam tape and/or a suction belt feedboard. Moreover, it is possible within the framework of the invention to also use, preferably polished, vacuum bars for the conveyance of the outer sheet provided with the fingers on a conveyor table.

Other embodiments of the instant invention are directed to bound flat parts, in particular sheets of paper. An outer sheet has several separately arranged individual fingers (on the end side), preferably arranged parallel and/or next to each other, and the fingers of an outer sheet are arranged in perforations of the stacked flat parts. The fingers are bent in a spiral-like manner or rolled (up) and one area of the fingers is brought into overlapping contact with another area of the respective finger, so that the fingers are unreleasably joined together in the contact area of the fingers. The end of the individual fingers facing away from the formed loops are connected with an outer sheet, which can be obtained through the execution of the method described above, in particular using an apparatus described above. The above explanations of the apparatus and method being incorporated herewith for the provisioning of the bound flat parts.

Moreover, it is preferred in the development of the bound flat parts that the ends of the individual fingers are arranged on the inside of the outer sheet, wherein in particular the fingers engage behind the webs, preferably designed on one edge of the outer sheet, of the respective perforations provided on the outer sheet for the fingers.

The ends of the individual fingers are also preferably arranged on the outside of the outer sheet.

For this, it is also provided that the outer sheet and the fingers of the outer sheet are made essentially of the same non-metallic, single-layer material and/or essentially have the same thickness.

It is thereby advantageous in an alternative, preferred further development that the outer sheet and the fingers are made of different, in particular non-metallic, materials and/or have different thicknesses and/or different colors or that the fingers are made of different, in particular non-metallic, materials and/or have different thicknesses and/or different widths and/or different lengths and/or different colors.

Variable variants that can be easily modified according to the requirements of the flat parts to be produced or produced bound are hereby reached in a simple manner.

Moreover, it is advantageous if the fingers, in particular in the visible area, have an embossing and/or an imprint and/or the fingers, in particular in the joining area with the outer sheet, have at least one creasing diagonal to the longitudinal extension of the fingers.

In a preferred embodiment of the flat parts produced bound as an (end) product, the distance between two binding tongues or fingers is equal to the width of the binding tongues or fingers.

In an alternative, preferred embodiment of the flat parts produced as (end) products, only two or three binding tongues or fingers are provided, the width of which is greater than the distance between the binding tongues or fingers.

It is in particular beneficial when, in the case of the bound flat parts, the outer sheet and the fingers of the outer sheet and the flat parts are made or produced of the same material.

Further characteristics of the invention will become apparent from the description of the embodiments according to the invention together with the claims and the included drawings. Embodiments according to the invention can fulfill individual characteristics or a combination of several characteristics.

Embodiments of the invention are directed to a method for binding stacked flat parts, which are provided with perforations. The method includes coupling several individual fingers on an outer sheet, applying an adhesive to a predetermined area of the fingers, inserting the fingers into the perforations of the stacked flat parts, so that the fingers are bent in a spiral-like manner, and positioning an portion of each finger in overlapping contact with the predetermined area of respective fingers.

According to embodiments, the stacked flat part can include sheets of paper. Moreover, the outer sheet, prior to having the several fingers coupled thereon in a preparatory step, can be finger free, and, prior to being positioned in overlapping contact, the portion may be adhesive free.

Embodiments of the instant invention are directed to a method for binding stacked flat parts, which are provided with perforations. The method includes coupling several individual fingers on an outer sheet, inserting the fingers of the outer sheet into the perforations of the stacked flat parts so that the fingers are bent in a spiral manner, positioning an area of each finger into overlapping contact with another area of a respective finger, and joining the overlapping contact areas together.

In accordance with other embodiments of the invention, the stacked flat part can include sheets of paper. Further, prior to the inserting, the fingers can be adhesive free, and the overlapping contact areas may be permanently joined together through at least one of radiation energy and an introduction of heat.

According to other embodiments, the outer sheet, prior to having the several fingers coupled thereon in a preparatory step, may be finger free.

Moreover, a plurality of the individual finger sections having a predetermined length can be held in at least one magazine, and, prior to the coupling, the method may further include guiding, one of simultaneously or in a predetermined sequence, individual finger sections from the at least one magazine to the outer sheet.

Still further, the individual fingers can be cut as finite finger sections having a predetermined length from at least one endless finger material strip, and, prior to the coupling, the method may further include guiding, one of simultaneously or in a predetermined sequence, the cut finger material strip sections to the outer sheet. The at least one finger material strip may include at least one coiled up strip.

According to still other embodiments, prior to the coupling, the method may include processing the fingers in at least one processing device, which can include at least one of a printing device and an embossing device.

In accordance with further embodiments, the method can include, prior to the coupling, applying glue to at least one of the fingers and the outer sheet with a predetermined glue pattern.

Further, the coupling may include inserting the individual fingers into perforations of the outer sheet, and connecting one of the ends of the individual fingers to the outer sheet, such that respective other ends of the individual fingers are arranged to extend from the outer sheet as free ends. The individual fingers connected to the outer sheet can be arranged so that each of the individual fingers engages behind the webs of respective perforations that are arranged on an edge of the outer sheet. Moreover, after binding the stacked flat parts, the one ends of the individual fingers connected with the outer sheet are arranged on a surface of the outer sheet arranged to face the bound flat parts.

Embodiments of the present invention are directed to an apparatus for the binding of stacked flat parts, which are provided with perforations. The apparatus includes an outer sheet assembling device structured and arranged to couple several individual fingers on an outer sheet, and a finger insertion device located on an output side of the outer sheet assembling device and structured and arranged to curve in a spiral-like manner and insert an area of the fingers into the perforations. A portion of each finger is positionable into overlapping contact with another area of a respective finger. A conveyor device is structured and arranged to convey the outer sheet with coupled fingers to the finger insertion device, and the finger insertion device includes a receiver structured and arranged to receive the stacked flat parts to be bound.

According to embodiments, the stacked flat parts can include sheets of paper, and the binding is achieved with a metal-free binding.

In accordance with other embodiments, the outer sheet assembling device may include at least one magazine structured to hold the individual fingers, which have a finite length, and the apparatus can further include a finger transfer device structured and arranged to convey, prior to the coupling, the individual fingers to the outer sheet.

Moreover, the outer sheet assembling device can include at least one receiving device structured and arranged to receive at least one of an endless and coiled up finger material strip and a cutting device structured and arranged to cut the finger material strip into individual fingers having a finite length, and the apparatus may further include a finger transfer device structured and arranged to convey, prior to the coupling, the individual fingers to the outer sheet.

According to still other embodiments of the invention, at least one of: the outer sheet assembling device may include at least one processing device for a finger material strip, such that the at least one processing device comprises at least one of a printing device and an embossing device, such that the processing device is arranged, relative to a conveying direction of the fingers to the outer sheet, in front of a location where the outer sheets are coupled to the fingers; and the outer sheet assembling device may include a glue application device structured and arranged for at least one of the individual fingers, the finger material strip, and the outer sheet.

Embodiments of the invention are directed to bound flat parts bound according to the above-described method. The bound flat parts include an outer sheet having several fingers. The fingers of the outer sheet are arranged through perforations of the stacked flat parts and bent in a spiral-like manner so that one area of the fingers is brought into overlapping contact with another area of respective fingers to form a loop. The fingers are unreleasably joined together in the overlapping contact area of the fingers, and ends of the fingers facing away from the formed loops are connected to the outer sheet.

Further, the fingers can be arranged at least one of parallel and next to each other.

Further embodiments of the instant invention can include at least one of: the ends of the fingers are arranged on an inside of the outer sheet, and portions of the fingers are arranged to engage behind webs arranged on an edge of the outer sheet to define parts of respective perforations in the outer sheet; the ends of the fingers are arranged on an outside of the outer sheet; the outer sheet and the fingers are at least one of made of different non-metallic materials, have different thicknesses and have different colors; and the fingers are at least one of made of different non-metallic materials, have different thicknesses, different widths, different lengths, and different colors.

According to other embodiments, in a visible area of the fingers, the fingers can include at least one of an embossing, imprinting, and at least one creasing diagonal to a longitudinal extension of the fingers in a joining area with the outer sheet.

In accordance with still yet other embodiments of the present invention, bound flat parts can be bound in the above noted apparatus. The bound parts include an outer sheet having several fingers. The fingers of the outer sheet are arranged through perforations of the stacked flat parts and bent in a spiral-like manner so that one area of the fingers is brought into overlapping contact with another area of respective fingers to form a loop. The fingers are unreleasably joined together in the overlapping contact area of the fingers, and ends of the fingers facing away from the formed loops are connected to the outer sheet.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a schematic view of a binding apparatus for the production of bound sheets of paper in a lateral view;

FIG. 2 illustrates a detailed schematic view of the apparatus in one cut;

FIG. 3 schematically illustrates a working position of the binding apparatus;

FIG. 4a, 4b schematically illustrates a simply screwed in or respectively produced binding loop;

FIG. 5a, 5b schematically illustrates a double screwed in or respectively produced binding loop;

FIG. 6 schematically illustrates a part of the binding apparatus for removal of a bound paper stack;

FIG. 7 schematically illustrates another working position on the binding apparatus;

FIG. 8a illustrates a schematic view of the top of the binding apparatus with the loop forming device omitted;

FIG. 8b, 8c illustrates a schematic side view of a magazine well (FIG. 8b) filled with binding tongues and of a bobbin received on a coiled material strip, which are arranged above a conveyor table of a binding apparatus;

FIG. 9 illustrates a schematic view of the top of a sheet of paper of a stack of papers to be bound;

FIG. 10a, 10b schematically illustrates views of a base sheet on the inside (FIG. 10) and the outside (FIG. 10b);

FIG. 10c schematically illustrates a cross-section through a base sheet with a binding tongue arranged or respectively fastened on one end on the inside;

FIG. 10d, 10e illustrates a schematic view of the top of an outer sheet or respectively base sheet with binding tongues with different lengths;

FIG. 11 schematically illustrates a perspective view of a stack of paper sheets produced and bound as (end) products; and

FIG. 12 illustrates a schematic cross-section through a bound stack of paper sheets.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

In the following figures, the same or similar types of elements or respectively corresponding parts are provided with the same reference numbers in order to prevent the item from needing to be reintroduced.

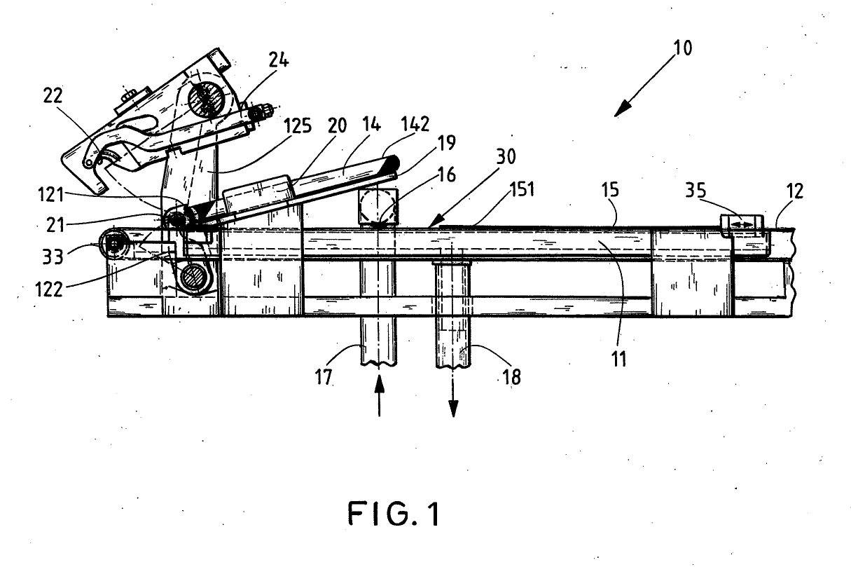

FIG. 1 shows a schematic view of part of the structure of a binding apparatus 10 for the binding of a stack 14 of several sheets of paper.

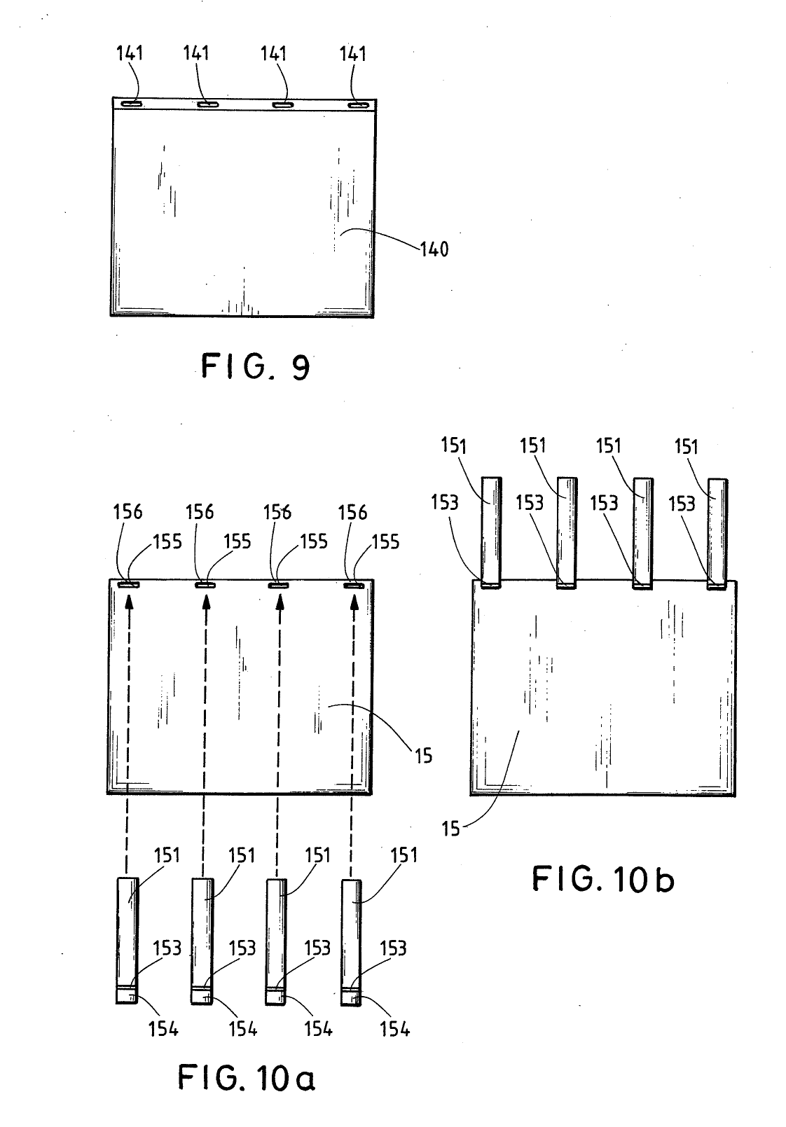

The stack 14 is formed of several sheets of paper, as they are schematically shown from the top in FIG. 9. The sheet of paper 140 shown in FIG. 9 has a right-angle base area, wherein several perforation holes 141 are designed in the (upper) edge area. The perforation holes 141 are designed as drawn-out slits, wherein a type of slit-like channel is formed through the perforation holes 141 in the case of the a block-wise arrangement or respectively stack-wise arrangement of several sheets of paper 140.

The stack 14 of stacked sheets of paper shown schematically in FIG. 1 is arranged on a tilted supporting table 19 with a fitted cover sheet 142 on the top side.

The binding apparatus 10 has a horizontally aligned conveyor table 30, which is arranged below the supporting table 19. In order to position the paper stack 14 together with the cover sheet 142 on the tilted supporting table 19, one or respectively more pivotable stack formers 21 is or are arranged on the bottom end of the supporting table 19 with partially circular contact surfaces for the paper stack 14, so that the perforations 141 of the paper stack form a partially circular channel in cross-section.

The stack formers 21 have a nose-like protrusion 121 on the top side, whereby the height or respectively thickness of the paper stack 14 to be bound is restricted. The stack formers 21 are arranged on a pivot arm 122 so that the stack formers 21 can be pivoted down and away.

Moreover, the supporting table 19 has corresponding guide plates 20 laterally, whereby the paper stack 14 in cooperation with the stack formers 21 is positioned exactly, so that the perforations 141 of the paper stack 14 form slit-like channels with a predetermined radius of curvature.

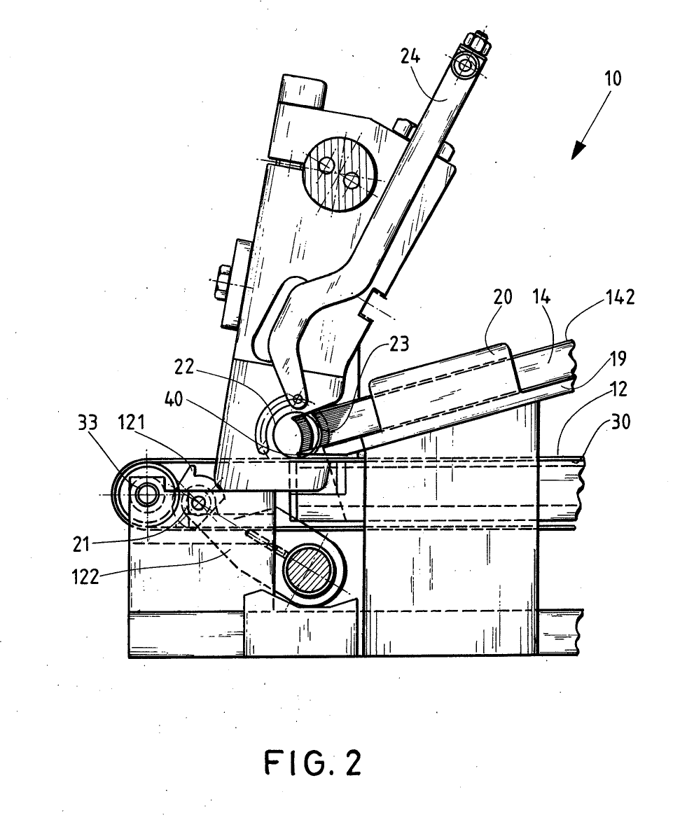

A binding loop forming device 22 is arranged above the bottom end of the supporting table 19 or above the stack formers 21. The binding loop forming device 22 is designed in a pivotable manner on a support or frame arm 125. In FIG. 1, the binding loop forming device 22 is shown pivoted up. The binding loop forming device 22 is pivoted over a center of pivot on the frame (see FIG. 2) until it is designed or arranged concentrically with the stack formers 21.

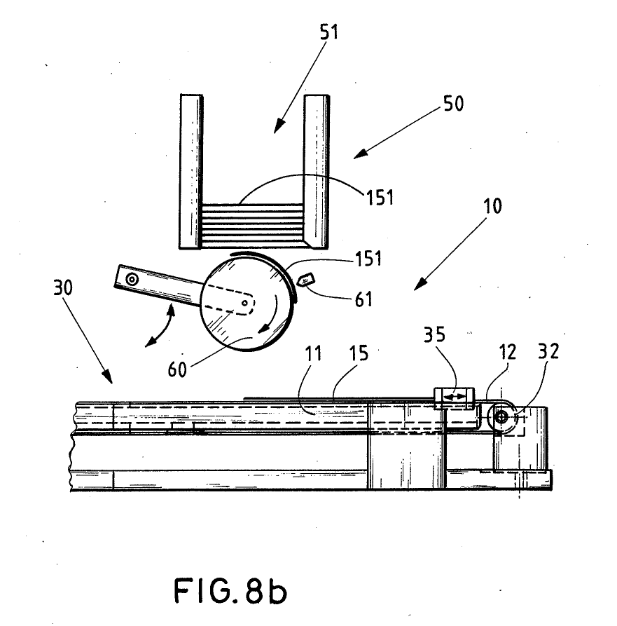

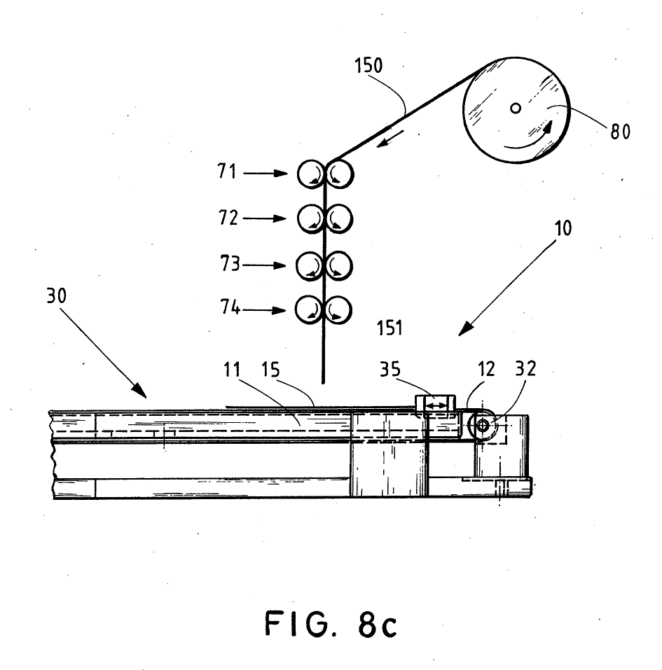

Moreover, the conveyor table 30 of the binding apparatus 10 has perforated suction belts 12, which are conveyed over outer rollers 32 (see FIG. 8b), 33. A suction plate 11 is arranged below the suction belts 12 in order to supply the suction belts 12 or respectively a base sheet 15 arranged on the suction belts 12 with negative pressure via a negative pressure connection 18. The base sheet 15 is hereby arranged above or respectively on a suction belt 12. A stop 35 that can be moved with the suction belts 12 is arranged on the outer right edge of the suction belt 12 and can be moved back and forth on the conveyor table 30 in order to move the base sheet 15 on the conveyor table 30.

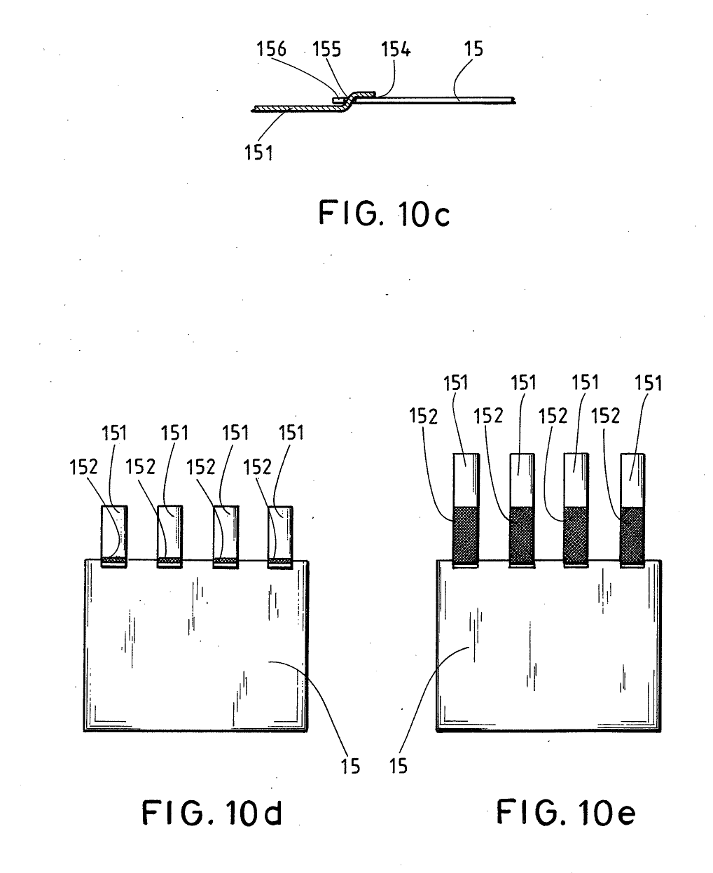

FIGS. 10a and 10b both show different schematic views of a base sheet 15. The base sheets 15 have a rectangular base area like the sheets of paper (see FIG. 9, reference number 140), wherein the base area of the base sheets 15 essentially corresponds with the base area of the sheets of paper 140 to be bound. Within the framework of the invention, it is also provided to process base sheets 15, which have a multi-side edge area protruding in particular on three sides.

FIG. 10a shows a view of the inside of a base sheet 15, while FIG. 10b shows the view of the outside of the base sheet 15. The base sheet 15 designed as outer sheet for a paper stack to be bound has several, preferably rectangular and/or punched-out, elongated holes 155, into which binding tongues 151 of a predetermined length are inserted. This is indicated in a simplified manner by the binding tongues 151 schematically shown in FIG. 10a below the base sheet 15 and the arrows drawn in. In the present exemplary embodiment, four binding tongues 151 are provided, the distance from each other of which is greater than its respective width or respectively the width of which is smaller than the distance between the binding tongues 151.

The binding tongues 151 are designed as separate material strip sections of a predetermined length. The binding tongues 151 in one embodiment can have an embossing or creasing 153 or the like on one end. Moreover, the binding tongues 151 have on the one end, which is connected with the base sheet 15, a glue surface 154, to which the one adhesive will be or is applied. For the fastening or arrangement of the binding tongues 151 on the base sheet 15, the binding tongues 151 are inserted or stuck into the elongated holes 151, wherein the glue surfaces 154 of the separate binding tongues 151 are arranged individually adhesively on the inside so that the binding tongues 151 with their glue surfaces 154 adhering to the inside of the base sheet 15 engage behind the elongated hole webs 156 designed between the elongated holes 155 and the outer longitudinal edge of the base sheet 15 (see FIG. 10c).

FIG. 10c schematically shows a section of a cross-section through a base sheet 15. The binding tongue 151 is arranged on one end on the inside of the base sheet 15 with its end-side glue surface 154 or respectively is connected with it. As can be seen from FIG. 10c, the binding tongue 151 is conveyed through the elongated hole 155 in a snake-like or S-like manner, wherein the free end of the binding tongue 151 pointing from the base sheet 15 is used for the binding of the paper stacks.

As can be seen from the schematic views of FIG. 10d, 10e, four tongue-like fingers or respectively binding tongues 151 with their free ends are arranged on a longitudinal side of the base sheets 15 provided for the binding of paper stacks, which are inserted into the perforations 141 of the paper sheets 140. In this further exemplary embodiment, four binding tongues 151 are provided in such a manner that the separation distance between binding tongues 151 is essentially the same as their width. For this, the binding tongues 151 are arranged at the spots where the perforation holes 141 are designed in the sheet of paper 140.

In order to insert the free ends of the binding tongues sticking out of the base sheet 15 or the binding tongues 151 of the base sheet 15 into the partially circularly designed channels of the perforation holes 141 of stacked sheets of paper, a base sheet 15 is arranged on each of the suction belts 12 of the binding apparatus according to FIG. 1. According to embodiments, the binding tongues 151 are not yet glued at first.

Using the binding apparatus 10 in FIG. 1, the base sheets 15 are arranged such that the binding tongues 151 are arranged on the side facing away from the stop 35 so that the binding tongues 151 point in the direction of the supporting table 19 or respectively the stack forming units 21.

The suction plate 11 is joined with a negative pressure source via a negative pressure connection 18 so that the base sheet 15 is held on the suction belts 12 through application of negative pressure.

In the case of a linear movement from left to right in accordance with FIG. 1, the binding tongues 151 are first conveyed under one or more glue nozzles 16 above the conveyor table 30, so that the binding tongues 151 are each provided with a trace of glue 152. The outer ends of the binding tongues 151 are hereby not provided with glue or respectively with an adhesive, while the areas of the bonding tongues 151 adjacent to the base area of the base sheet 15 are provided with glue. The glue is thereby conveyed to the glue nozzles 16 via a glue feed line 17.

Reference number 152 in FIG. 10d, 10e shows the adhesive application areas or respectively the glue traces on the binding tongues 151. The base area of the base sheets 15 thereby remains adhesive- or respectively glue-free.

In another embodiment, glue or adhesive is applied to both sides of the binding tongues 151 at predetermined spots.

The length and the quantity of the glue traces 152 on the binding tongues 151 thereby depend on the length of the binding tongues and the preferred shape of the provided loops for the binding of the paper stack.

FIG. 2 shows a detailed view of a working position of the binding loop forming device 22. Guide shells 23 are inserted into the pre-punched perforations 141 or respectively the pre-punched binding slits of the sheets of paper 140 of the stack 14 after the binding loop forming device 22 pivots into position through actuation of a control lever 24. The stack formers 21 are then pivoted down and away.

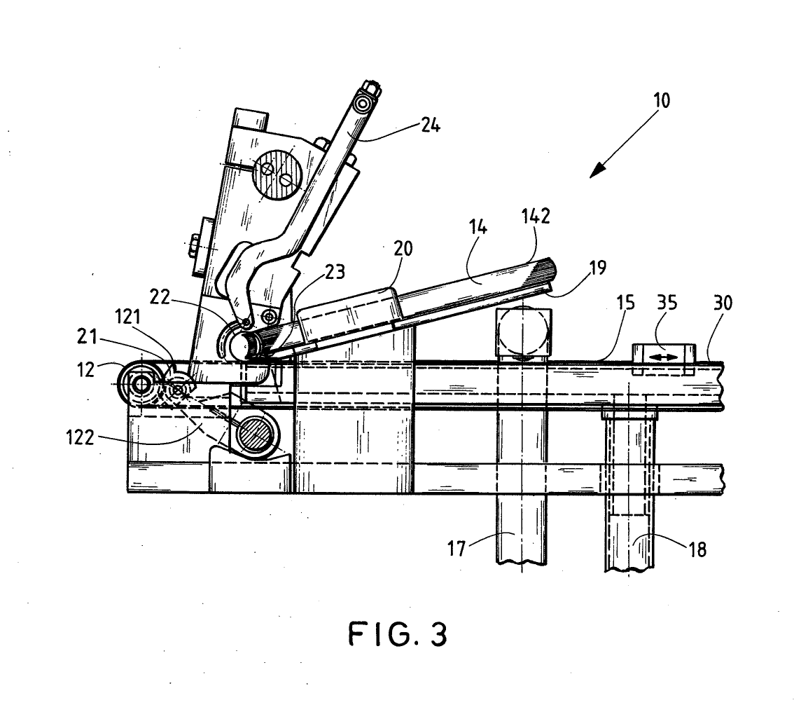

As can be seen from FIG. 2, a gap 40 is designed between the bottom side of the supporting table 19 and the suction belt 12 of the conveyor table 30 or respectively between the ends of the guide shells 23 and the suction belt 12, through which the base sheet 15 is guided with the binding tongues 151. Each of the base sheets 15 arranged on the suction belts 12 are conveyed in the direction of the binding loop forming device 22 by the moveable stop 35. At the beginning radius of the guide shells 23 of the binding loop forming device 22, the negative pressure on the suction belts 12 will be or respectively is interrupted so that the binding tongues 151 run into the circular guide shells 23 and are bent or curved (see FIG. 3).

The guide shells 23 designed as an elongated guide for the binding tongues 151 are swung in after a concentric positioning with respect to the stack former 21 through the perforations of the stack of flat parts or respectively of the stack 14 under the formation of a circular arc so that the binding tongues 151 will be or respectively are conveyed in a curved manner during insertion into the perforations via a circular arc of more than 350°, preferably 355°. In order to reduce the friction of the binding tongues 151 on the insides of the guide shells 23 during the insertion or respectively curving in of the binding tongues 151 into the perforations of the stack 14, air is introduced between the binding tongues 151 and the inside of the guide shells 23 using an air nozzle. In this manner, a type of air bearing for the binding tongues 151 is provided to support a coiling formation of the binding tongues 151 or respectively of the binding loops.

The guide shells 23 take on the shape of the sheets of paper 140 of the stack 14 on the outer radius during the formation of the loops and guide the inserted binding tongues 151 on the inner radius during formation of the loops.

During the conveyance of the base sheet 15 on the suction belt 12, it is conveyed below the glue nozzles 16 with its inside or respectively with its binding tongues 151 so that that binding tongues 151 are provided with a trace of glue (see FIG. 10d, 10e, reference number 152). A specified area of the binding tongues 151 is hereby sprayed or respectively provided with a predetermined glue pattern in order to then be bent after insertion of the binding tongues 151 into the channels formed by the perforation holes 141 along the guide shells 23. Under continuous transport of the base sheet 15, the front ends of the binding tongues 151 are conveyed by 360° on a circular track, whereby the front ends of the binding tongues 151 are brought in contact with the glue track 152 of the binding tongues 151 applied on the inside. In this way, an unreleasable loop or respectively binding loop is formed.

FIG. 3 shows the working situation, in which the base sheet 15 with the binding tongues 151 arranged on it or respectively glued inside on the suction rings 12 is inserted into the binding loop forming device 22. Due to the curvature of the guide shells 23 the binding tongues 151 lie against the inside of the guide shells 23 and are thus inserted through the slit-like channel or respectively the slit-like channels in the stack 14, which is or are formed through the perforations of the paper stack 14.

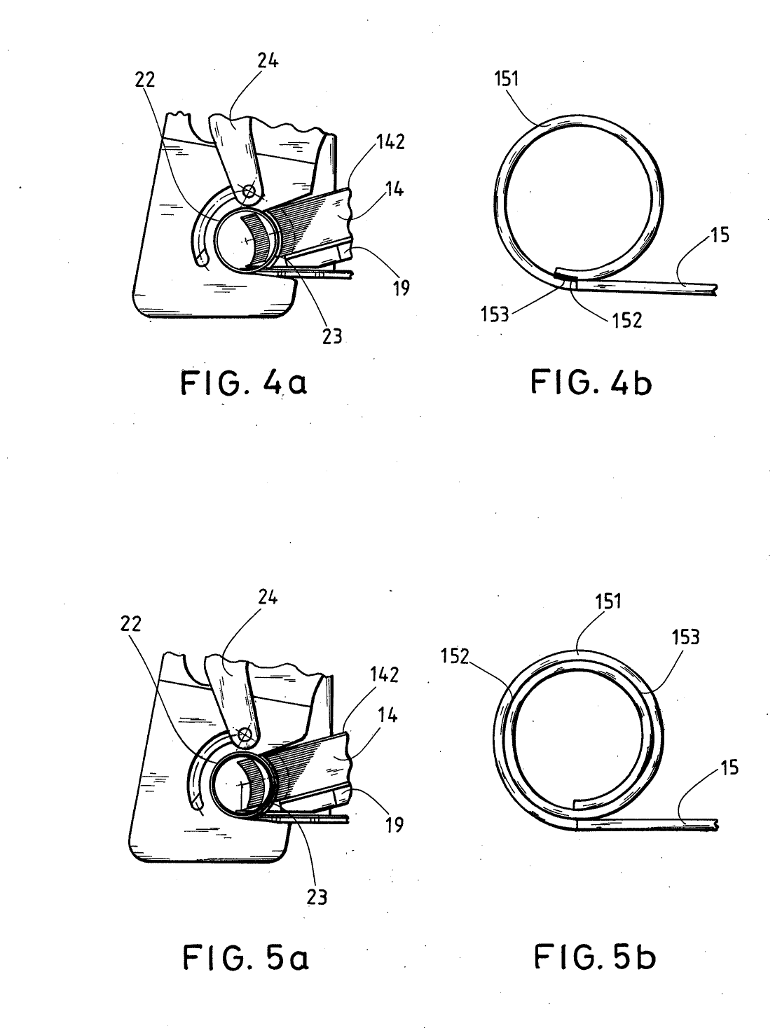

FIG. 4a shows schematically a single curved-in binding loop, which is shown enlarged in FIG. 4b with the paper stack 14 omitted. As can be seen from FIG. 4b, the front end of the binding tongue 151 is designed with the glue trace 152 in an overlapping contact area 153.

FIG. 5a or respectively 5b show a schematic cross-section of a double curved-in or respectively designed binding loop. In the enlarged representation in accordance with FIG. 5b the paper stack 14 was also omitted for the sake of clarity. In the case of the binding loop formed in accordance with FIG. 5a, 5b, the contact area or the glue trace 152 is designed over a circumference of 360°. Depending on the material strength of the base sheet 15 or the binding tongues 151, the stability of the formed loops can be increased.

In the case of the double loop shown according to FIG. 5a, 5b, the pivoted-in guide shells 23 can be pivoted back before the formation of the double loop, since an already created single loop takes over the guide of the inner loop for the double loop. The binding loops produced according to the invention are designed with a spiral-like cross-section, wherein the contact area or respectively the length of the glue trace is selected or respectively predetermined according to the desired binding loop shape.

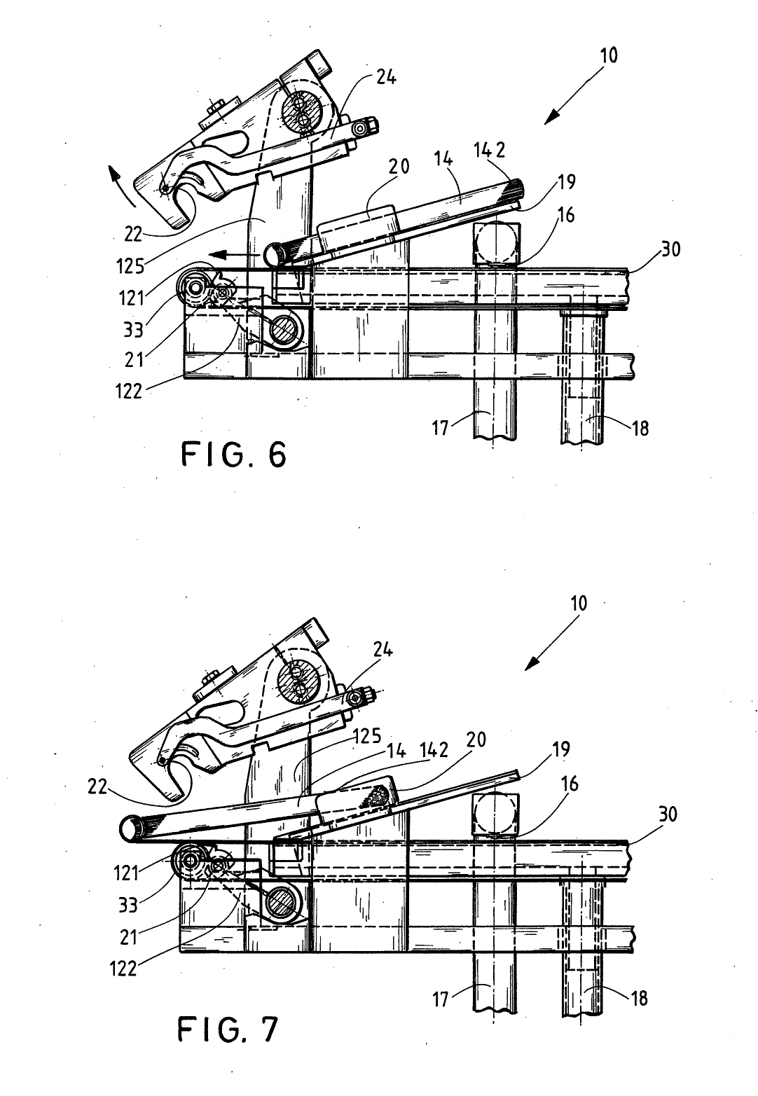

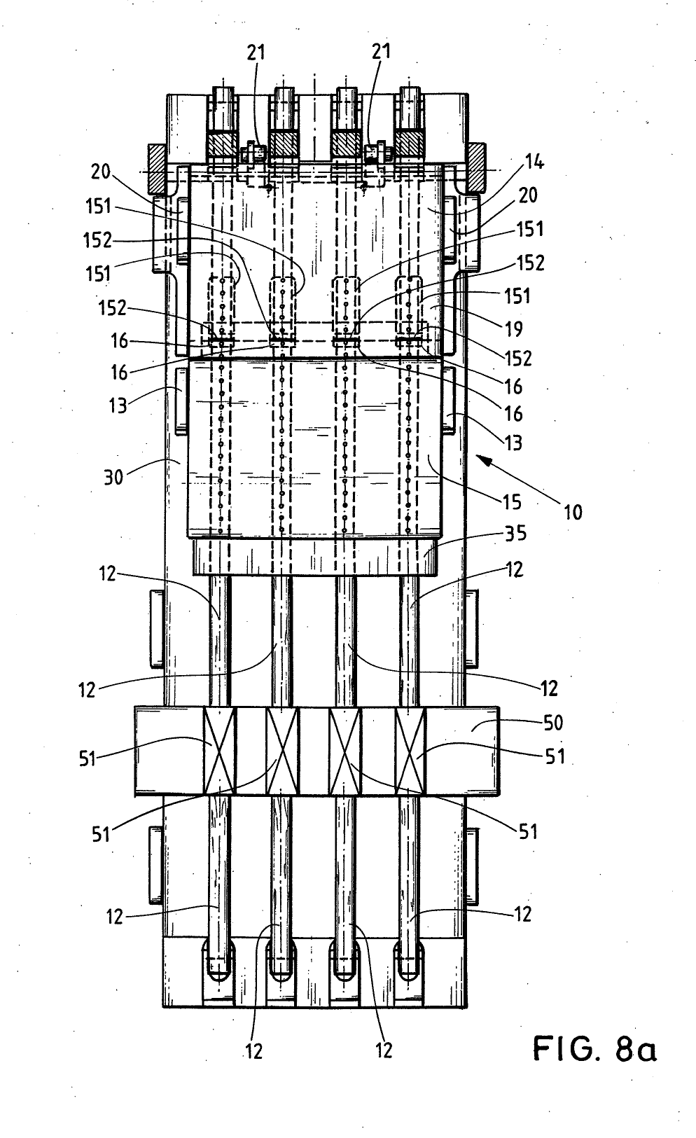

After the formation of a loop, the binding loop forming device 22 is pivoted away as is shown schematically in FIG. 6. The bound paper stack 14 together with the loop formed by the binding tongues 151 of the base sheet 15 is then completely removed from the binding apparatus as is shown schematically in FIG. 7.

FIG. 8a shows a schematic view of the top of the binding apparatus 10, in which the binding loop forming device was omitted for the sake of clarity. As can be seen in FIG. 8a, the conveyor table 30 has lateral guide plates or guide rails 13 in order to ensure a secure positioning of the base sheet 15 on the suction belts.

FIG. 8a also shows a base sheet 15, wherein the binding tongues 151 are marked with dashed lines below the supporting table 19. Moreover, the glue nozzles 16, which are also marked with dashed lines, apply a trace of glue 152 (see FIG. 10d) at least in the root area of the binding tongues 151.

As can be further seen from FIG. 8a, the stack formers 21 are arranged between the suction belts 12 or the guide shells 23 of the binding loop forming device 22.

The binding apparatus 10 has a multi-chamber magazine 50 on the side facing away from the supporting table 19, wherein the multiple magazine 50 has several magazine wells 51, in which provided binding tongues 151 as stacks are filled in as material sections with a predetermined length. Several binding tongues 151 are removed simultaneously from each of the magazine wells 51 and conveyed to the finger-free base sheet 15 arranged on the supporting table or respectively on the suction belts 12.

During the conveyance of the binding tongues 151 from the magazine wells 51 to the base sheet 12, the binding tongues 151 are advantageously transported past a gluing device, so that during transport the glue surfaces 154 (see FIG. 10a) of the binding tongues 151 are provided with an adhesive, in order to subsequently arrange the binding tongues 151 in the edge area of the longitudinal side of the base sheet 15.

Moreover, it is possible during the conveyance of the individual binding tongues 151 to the base sheet 12 to provide the binding tongues 151 with an imprint or an embossing or the like through a corresponding processing device. For this, the processing device is correspondingly designed for example as a printing device or as an embossing device or as a die-cutting device.

In order to arrange the binding tongues 151 on the base sheet 12 (see FIG. 10a), the binding tongues 151 are inserted into the elongated holes (see FIG. 10a, reference number 155) of the base sheet 12 via a corresponding device, such as a folding device or the like, so that the pulling through of the binding tongues 151 the end areas of the binding tongues 151 provided with adhesive are brought into adhesive contact with the inside of the base sheet 12. Within the framework of the invention, it is also possible that the binding tongues are also permanently arranged or connected on the (later) outside of the base sheets.

FIG. 8b shows schematically a cross-section of a side view of the removal of the binding tongues 151 from a magazine shaft 51. Binding tongues 151 are arranged stacked in the magazine well 51, and are removed and conveyed in their longitudinal direction by a withdrawal device arranged below the magazine well 51 in the form of a rotatable removal wheel 60 pivotable on a pivot arm.

A glue nozzle 61 is arranged next to the rotatingly driven removal wheel 60 so that, under conveyance of the picked-up binding tongue 151 in a predetermined position, glue or adhesive or the like is applied to one end of the binding tongue 151. The glued binding tongue 151 is then arranged with one end on the base sheet 15 using appropriate devices. The number and position of the laterally spaced magazine wells 51 preferably match the number of binding tongues 151 to be simultaneously attached to the base sheet 15.

Alternatively or additionally to the gluing of the binding tongues 151, it is possible in one embodiment of the apparatus that the base sheet 12 in the edge area, in which the ends of the binding tongues 151 are arranged, are provided with an adhesive in order to connect the conveyed binding tongues 151 in this area with the base sheet 15.

FIG. 8c shows a schematic cross-section of an alternative embodiment for conveying binding tongues 151 to a base sheet 15. An endless material strip 150 wound onto a bobbin 80 is removed by a draw-off roller pair 71 and then conveyed to a printing device in the form of a printing roll pair 72 so that an imprint is imprinted on the material strip 150. The number and position of the laterally spaced magazine strips 150 preferably match the number of binding tongues 151 to be simultaneously applied or respectively attached. Alternatively or additionally, an embossing on the material strip 150 can also be applied by a corresponding embossing device.

After the printing device 72, the endless material strip 150 is conveyed to a cutting device 73 in the form of a rotating knife drum so that binding tongues 151 with a predetermined length are cut from the endless material strip 150. The cut binding tongues 151 of finite length are then conveyed to a glue application device in the form of a glue roll pair 74 in order to apply glue to one end of the binding tongues 151 so that the glued end is permanently connected with the base sheet 15.

In an advantageous embodiment of the outer sheet assembling device, the rotational axes of the conveyor devices and processing devices 60, 80, 71, 72, 73, 74 are arranged diagonally, in particular perpendicular, to the conveying direction of the base sheet 15 or respectively of the suction belts 12.

Moreover, it is provided within the framework of the invention in one embodiment that during the conveyance of the material strip 150 or the binding tongues 151 it is broken by a breaking device on the (later) inside of the binding tongues. In this manner, the coil formation or respectively loop formation is supported. Since the broken binding tongues 151 are held flat on the suction table during transport to the binding loop forming device, collapsing during the screwing of the loop is avoided.

Within the framework of the invention, it is possible that instead of the schematically shown processing devices other or additional processing devices are also provided in order to apply corresponding imprints or embossings or press cuts or other glue patterns to the material strip 150. Alternatively or additionally, the binding apparatus 10 can also have a glue application device for the base sheet so that the later connection spots with the binding tongues on the base sheet 15 are provided with glue or adhesive or the like.

Moreover, in another embodiment of the binding apparatus 10 (not shown here), it can be provided that the binding tongues required for each base sheet 15 are cut, preferably one after the other, from just one or exclusively one material strip struck off from a bobbin 80, wherein after the cutting of the binding tongues they are spaced in order to be subsequently fed to the corresponding elongated holes of the base sheet 15 by a corresponding transfer device (also not shown here).

In this further advantageous embodiment of the outer sheet assembling device, the rotational axes of the conveyor devices and the processing devices, such as the bobbin axis, a printing device, a diagonal cutting device, an embossing device and/or a creasing device, are preferably arranged parallel to the conveyor device of the base sheet 15 or respectively of the suction belts 12. A gluing or other processing of the binding tongues or respectively of the material strip can hereby take place before or after the cutting of the binding tongues from the material strips.

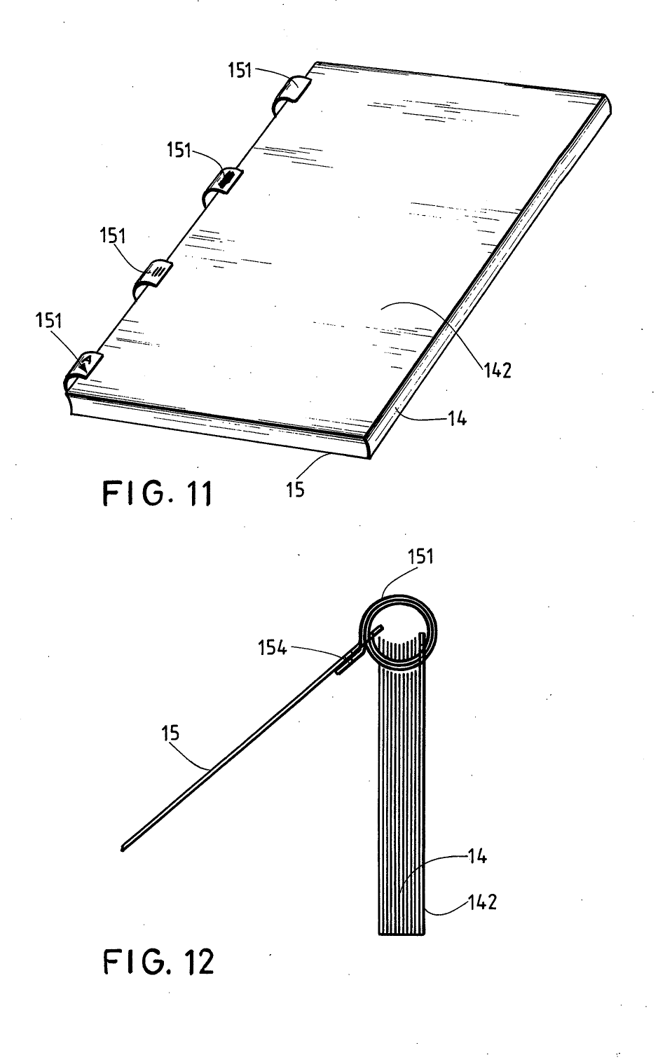

FIG. 11 shows schematically a perspective view of a bound paper stack 14, in which the cover sheet 142 is arranged on the top side and the base sheet 15 is arranged on the bottom side. Through the loop-like rolling in of the binding tongues 151, the paper stack 14 is permanently bound, and the binding tongues 151 are correspondingly processed, for example, during their conveyance to the base sheet 15 so that the binding loops 151 are imprinted, for example, by a printing device. Moreover, it is also possible to die-cut the binding tongues or to provide them with an embossing on the outside by an embossing device.

Depending on the paper stacks to be bound, it is possible within the framework of the invention that the length and/or the width and/or the thickness of the binding tongues 151 is selected depending on demand or respectively the length and/or the width and/or the thickness is set accordingly. Moreover, it is also possible to predetermine the color of the binding tongues 151 in order to give the bound product the desired colored appearance.

FIG. 12 shows schematically a cross-section of a bound end product. Through the binding according to the invention the binding tongues 151 provided with the glue surface 154 is arranged on the inside of the base sheet 15. The binding tongue 151 is conveyed through an elongated hole in the base sheet 15 (see FIG. 10c) so that after application of glue surfaces 154 to the desired areas of the binding tongues 151 the free ends of the binding tongues 151 are inserted into a stack 14 with a cover sheet 142 and are designed in a loop-like manner.

In accordance with the invention, pre-punched flat parts, such as sheets of paper, are bound, in such a manner that the binding loops are arranged or respectively glued in or respectively on the base sheet or on the cover sheet or respectively outer sheet. According to the provided binding type, e.g. single loop or double loop, the lengths and the number of binding tongues on the base sheet or cover sheet are cut out and then shaped into a loop on the flat part stack to be bound by a binding loop forming device 22 and curved into the flat part stack.

Moreover, it is possible within the framework of the invention that the material for the base sheet or the cover sheet with the individual binding tongues arranged on it later has substances, such that, after formation of a binding loop, the sheet material is exposed to a radiation source in order to reduce the flexibility of the material. In this way, the state of the loop is retained and a firm writing pad or the like is simultaneously achieved.

Through the cutting of the binding tongues and the more or less screwing into the binding loop, different loop diameters are created, such that different paper layer thicknesses can be bound with fewer cuts in the base or cover sheets. Furthermore, the formed binding loops on the transfer point are immobilized with adhesive after 360°. In this way, the material bound by the binding loops or respectively the bound stack cannot be removed from the binding loop later on.

Furthermore, it is possible within the framework of the invention that the outer sheet used (base sheet or cover sheet) is designed in a rounded manner in particular at the spots that are formed for the binding loop. This creates a good gliding behavior through the loop former.

Moreover, it is possible within the framework of the invention that a magazine is provided on the binding apparatus for the base sheets or respectively outer sheets. In this manner, an automatic work process is achieved on the binding apparatus.

All named characteristics, including those taken from the drawings alone, and individual characteristics, which are disclosed in combination with other characteristics, are considered alone and in combination as important to the invention. Embodiments according to the invention can be fulfilled through individual characteristics or a combination of several characteristics.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### LIST OF REFERENCES

10 Binding apparatus
11 Suction plate
12 Suction belts
13 Guide plates
14 Stack
15 Base sheet
16 Glue nozzle
17 Glue feed line
18 Negative pressure connection
19 Supporting table
20 Guide plate
21 Stack formers
22 Binding loop forming device
23 Guide shell
24 Control lever
30 Conveyor table
32 Roll
33 Roll
35 Stop
40 Gap
50 Multiple magazine
51 Magazine well
60 Removal wheel
61 Glue nozzle
70 Bobbin
71 Draw-off roller pair
72 Printing device
73 Cutting device
74 Glue application device
80 Bobbin
121 Protrusion
122 Pivot arm
125 Support arm
140 Sheet of paper
141 Perforation holes
142 Cover Sheet
150 Material strip
151 Binding tongues
152 Glue trace
153 Creasing
154 Glue surface
155 Elongated hole
156 Elongated hole web

What is claimed:

1. A method for binding stacked flat parts, which are provided with perforations, comprising:
coupling several individual fingers on an outer sheet;
applying an adhesive to a predetermined area of the fingers;
inserting the fingers into the perforations of the stacked flat parts, whereby the fingers are bent in a spiral-like manner;
positioning an portion of each finger in overlapping contact with the predetermined area of respective fingers.

2. The method in accordance with claim 1, wherein the stacked flat part comprise sheets of paper,
wherein the outer sheet, prior to having the several fingers coupled thereon in a preparatory step, is finger free, and
wherein, prior to being positioned in overlapping contact, the portion is adhesive free.

3. A method for binding stacked flat parts, which are provided with perforations, comprising:
coupling several individual fingers on an outer sheet;
inserting the fingers of the outer sheet into the perforations of the stacked flat parts so that the fingers are bent in a spiral manner,
positioning an area of each finger into overlapping contact with another area of a respective finger; and
joining the overlapping contact areas together.

4. The method in accordance with claim 3, wherein the stacked flat part comprise sheets of paper,
wherein, prior to the inserting, the fingers are adhesive free, and
wherein the overlapping contact areas are permanently joined together through at least one of radiation energy and an introduction of heat.

5. The method according to claim 3, wherein the outer sheet, prior to having the several fingers coupled thereon in a preparatory step, is finger free.

6. The method according to claim 3, wherein a plurality of the individual finger sections having a predetermined length are held in at least one magazine, and, prior to the coupling, the method further comprises guiding, one of simultaneously or in a predetermined sequence, individual finger sections from the at least one magazine to the outer sheet.

7. The method according to claim 3, wherein the individual fingers are cut as finite finger sections having a predetermined length from at least one endless finger material strip, and, prior to the coupling, the method further comprises guiding, one of simultaneously or in a predetermined sequence, the cut finger material strip sections to the outer sheet.

8. The method according to claim 7, wherein the at least one finger material strip comprise at least one coiled up strip.

9. The method according to claim 3, wherein, prior to the coupling, the method comprises processing the fingers in at least one processing device comprising at least one of a printing device and an embossing device.

10. The method according to claim 3, wherein, prior to the coupling, applying glue to at least one of the fingers and the outer sheet with a predetermined glue pattern.

11. The method according to claim 3, wherein the coupling comprises inserting the individual fingers into perforations of the outer sheet, connecting one of the ends of the individual fingers to the outer sheet, whereby respective other ends of the individual fingers are arranged to extend from the outer sheet as free ends, and
wherein the individual fingers connected to the outer sheet are arranged so that each of the individual fingers engage behind the webs of respective perforations that are arranged on an edge of the outer sheet.

12. The method according to claim 11, wherein, after binding the stacked flat parts, the one ends of the individual fingers connected with the outer sheet are arranged on a surface of the outer sheet arranged to face the bound flat parts.

13. An apparatus for the binding of stacked flat parts, which are provided with perforations, comprising:
an outer sheet assembling device structured and arranged to couple several individual fingers on an outer sheet;
a finger insertion device located on an output side of the outer sheet assembling device and structured and arranged to curve in a spiral-like manner and insert an area of the fingers into the perforations, wherein a portion of each finger is positionable into overlapping contact with another area of a respective finger;
a conveyor device structured and arranged to convey the outer sheet with coupled fingers to the finger insertion device,
wherein the finger insertion device includes a receiver structured and arranged to receive the stacked flat parts to be bound.

14. The apparatus according to claim 13, wherein the stacked flat parts comprise sheets of paper, and the binding is achieved with a metal-free binding.

15. The apparatus according to claim 13, wherein the outer sheet assembling device includes at least one magazine structured to hold the individual fingers, which have a finite length, and the apparatus further comprises a finger transfer device structured and arranged to convey, prior to the coupling, the individual fingers to the outer sheet.

16. The apparatus according to claim 13, wherein the outer sheet assembling device includes at least one receiving device structured and arranged to receive at least one of an endless and coiled up finger material strip and a cutting device structured and arranged to cut the finger material strip into individual fingers having a finite length, and the apparatus further comprising a finger transfer device structured and arranged to convey, prior to the coupling, the individual fingers to the outer sheet.

17. The apparatus according to claim 13, wherein at least one of:
the outer sheet assembling device comprises at least one processing device for a finger material strip, wherein the at least one processing device comprises at least one of a printing device and an embossing device, such that the processing device is arranged, relative to a conveying direction of the fingers to the outer sheet, in front of a location where the outer sheets are coupled to the fingers; and
the outer sheet assembling device comprises a glue application device structured and arranged for at least one of the individual fingers, the finger material strip, and the outer sheet.

18. Bound flat parts bound according to the method of claim 1, comprising:
an outer sheet having several fingers;
the fingers of the outer sheet are arranged through perforations of the stacked flat parts and bent in a spiral-like manner so that one area of the fingers is brought into overlapping contact with another area of respective fingers to form a loop;
wherein the fingers are unreleasably joined together in the overlapping contact area of the fingers, and
ends of the fingers facing away from the formed loops are connected to the outer sheet.

19. The bound flat parts according to claim 18, wherein the fingers are arranged at least one of parallel and next to each other.

20. The bound flat parts according to claim 18, wherein at least one of:
the ends of the fingers are arranged on an inside of the outer sheet, and portions of the fingers are arranged to engage behind webs arranged on an edge of the outer sheet to define parts of respective perforations in the outer sheet;
the ends of the fingers are arranged on an outside of the outer sheet;
the outer sheet and the fingers are at least one of made of different non-metallic materials, have different thicknesses and have different colors; and
the fingers are at least one of made of different non-metallic materials, have different thicknesses, different widths, different lengths, and different colors.

21. The bound flat parts according to claim 18, wherein in a visible area of the fingers, the fingers include at least one of an embossing, imprinting, and at least one creasing diagonal to a longitudinal extension of the fingers in a joining area with the outer sheet.

22. Bound flat parts bound in the apparatus of claim 13, comprising:
an outer sheet having several fingers;
the fingers of the outer sheet are arranged through perforations of the stacked flat parts and bent in a spiral-like manner so that one area of the fingers is brought into overlapping contact with another area of respective fingers to form a loop;
wherein the fingers are unreleasably joined together in the overlapping contact area of the fingers, and
ends of the fingers facing away from the formed loops are connected to the outer sheet.
